(19) United States
(12) Patent Application Publication
(10) Pub. No.: US 2013/0179166 A1
(43) Pub. Date: Jul. 11, 2013

(54) VOICE CONVERSION DEVICE, PORTABLE TELEPHONE TERMINAL, VOICE CONVERSION METHOD, AND RECORD MEDIUM

(71) Applicant: Toshihiko Fujibayashi, Kanagawa (JP)

(72) Inventor: Toshihiko Fujibayashi, Kanagawa (JP)

(73) Assignee: NEC CASIO Mobile Communications, Ltd., Kanagawa (JP)

(21) Appl. No.: 13/818,889

(22) PCT Filed: Sep. 6, 2011
(86) PCT No.: PCT/JP2011/070248

§ 371 Date: Feb. 25, 2013

(30) Foreign Application Priority Data
Sep. 29, 2010 (JP) 2010-219053

(51) Int. Cl. G10L 15/26

(52) U.S. Cl. CPC G10L 15/26
USPC 704/235

(57) ABSTRACT

A portable-telephone terminal frees the user from repeatedly performing a correction process. A voice-conversion device includes a voice-recognition unit accepting a voice and converting the voice into a character string; a display unit displaying the character string; a correction unit accepting a correction command that causes a word or a phrase being a part of a character string displayed on the display unit to be corrected and correcting the word or phrase corresponding to the correction command; a storage unit storing a word or a phrase corrected by the correction unit; and a control unit generating a selection candidate corresponding to the corrected word or phrase of the character string and displaying the selection candidate as a recognition-result candidate of the voice on the display unit if the corrected word or phrase has been stored in the storage unit when the voice-recognition unit converts the voice into the character string.

### TECHNICAL FIELD

The present invention relates to a voice conversion device, a portable telephone terminal, a voice conversion method, and a record medium.

### BACKGROUND ART

When a voice recognition engine with which a device such as a portable telephone terminal is provided performs a voice recognition process, a word or phrase that the user speaks does not always match its voice recognition result.

Although the inconsistency between a word or a phrase that the user speaks and its voice recognition result depends on the recognition rate of the voice recognition engine itself, the inconsistency also depends on other factors such as the user's speaking habit, his or her accent, and microphone's characteristics.

Thus, the user needs to perform an optimization process (correction process) that corrects an incorrect voice recognition result to a correct word or phrase.

Patent Literature 1 describes a voice recognition unit that allows the user to correct an incorrect voice recognition result using his or her correct voice and that stores the corrected result, specifically, a pre-corrected voice recognition result and a post-corrected voice recognition result.

In the voice recognition unit described in Patent Literature 1, when the voice recognition result has been corrected with a user's correct voice and if the unit further accepts his or her correct voice, the unit outputs the correction result acquired this time, namely an incorrect voice recognition result.

### RELATED ART LITERATURE

### Patent Literature

Patent Literature 1: JP2007-93789A, Publication

### SUMMARY OF THE INVENTION

### Problem to be Solved by the Invention

In the voice recognition unit described in Patent Literature 1, the content of corrections that were made in the past are reflected only in a voice recognition result that has been repeatedly corrected with the correct voice, not in a new voice recognition result.

Thus, in the voice recognition unit described in Patent Literature 1, it is likely that a recognition error will occur in each new voice recognition result. Thus, if a recognition error that the user corrected in the past occurs in a new voice recognition result, since he or she needs to repeat the same correction process (optimization process) as he or she did in the past, he or she finds this to be troublesome.

An object of the present invention is to provide a voice conversion device, a portable telephone terminal, a voice conversion method, and a record medium that can solve the foregoing problem.

### Means That Solve the Problem

A voice conversion device according to the present invention includes voice recognition means that accepts a voice and converts the voice into a character string; display means that displays said character string; correction means that accepts a correction command that causes a word or a phrase that is a part of a character string displayed on said display means to be corrected and corrects said word or phrase corresponding to the correction command; storage means that stores a word or a phrase corrected by said correction means; and control means that generates a selection candidate corresponding to the corrected word or phrase of the character string and displays the selection candidate as a recognition result candidate of said voice on said display means if the corrected word or phrase has been stored in said storage means when said voice recognition means converts the voice into the character string.

A voice conversion device according to the present invention is a voice conversion device that is capable of communicating with a voice recognition unit that receives voice data, converts the voice data into a character string, and transmits the character string to a sender of said voice data, the voice conversion device including output means that converts an input voice into voice data; communication means that transmits said voice data to said voice recognition unit and then receives a character string as a conversion result of said voice data from said voice recognition unit; display means that displays said character string; correction means that accepts a correction command that causes a word or a phrase that is a part of a character string displayed on said display means to be corrected and corrects the word or phrase of said character string corresponding to the correction command; storage means that stores a word or a phrase corrected by said correction means; and control means that generates a selection candidate corresponding to said corrected word or phrase of the character string and displays the selection candidate as a recognition result candidate of said voice on said display means if the corrected word or phrase has been stored in said storage means when said communication means receives the character string from said voice recognition unit.

A voice conversion method according to the present invention is a voice conversion method for a voice conversion device, the voice conversion method including accepting a voice and converting the voice into a character string; displaying said character string on display means; accepting a correction command that causes a word or a phrase that is a part of a character string displayed on said display means to be corrected and correcting said word or phrase corresponding to the correction command; storing said corrected word or phrase in storage means; and generating a selection candidate corresponding to the corrected word or phrase of the character string and displaying the selection candidate as a recognition result candidate of said voice on said display means if the corrected word or phrase has been stored in said storage means when said voice is converted into the character string.

A voice conversion method according to the present invention is a voice conversion method for a voice conversion device that is capable of communicating with a voice recognition unit that receives voice data, converts the voice data into a character string, and transmits the character string to a sender of said voice data, the voice conversion method including converting an input voice into voice data; transmitting said voice data to said voice recognition unit and then receiving a character string as a conversion result of said voice data from said voice recognition unit; displaying said character string on display means; accepting a correction command that causes a word or a phrase that is a part of a character string displayed on said display means to be corrected and correcting the word or phrase of said character string corresponding to the correction command; storing said corrected word or phrase in storage means; and generating a selection candidate corresponding to said corrected word or phrase of the character string and displaying the selection candidate as a recognition result candidate of said voice on said display means if the corrected word or phrase has been stored in said storage means when the character string is received from said voice recognition unit.

A record medium according to the present invention is a computer readable record medium that stores a program that causes a computer to execute the procedures including a voice recognition procedure that accepts a voice and converts the voice into a character string; a display procedure that displays said character string on display means; a correction procedure that accepts a correction command that causes a word or a phrase that is a part of a character string displayed on said display means to be corrected and corrects said word or phrase corresponding to the correction command; a storage procedure that stores said corrected word or phrase in storage means; and a control procedure that generates a selection candidate corresponding to the corrected word or phrase of the character string and displays the selection candidate as a recognition result candidate of said voice on said display means if the corrected word or phrase has been stored in said storage means when said voice is converted into the character string.

A record medium according to the present invention is a computer readable record medium that stores a program that causes a computer that is capable of communicating with a voice recognition unit that receives voice data, converts the voice data into a character string, and transmits the character string to a sender of said voice data, to execute the procedures including an output procedure that converts an input voice into voice data; a communication procedure that transmits said voice data to said voice recognition unit and then receives a character string as a conversion result of said voice data from said voice recognition unit; a display procedure that displays said character string on display means; a correction procedure that accepts a correction command that causes a word or a phrase that is a part of a character string displayed on said display means to be corrected and corrects the word or phrase of said character string corresponding to the correction command; a storage procedure that stores said corrected word or phrase in storage means; and a control procedure that generates a selection candidate corresponding to said corrected word or phrase of the character string and displays the selection candidate as a recognition result candidate of said voice on said display means if the corrected word or phrase has been stored in said storage means when the character string is received from said voice recognition unit.

### Effect of the Invention

According to the present invention, the user can be free from repeating the same correction process (optimization process).

### BRIEF DESCRIPTION OF DRAWINGS

FIG. 1 is a block diagram showing portable telephone terminal 1 according to an embodiment of the present invention.

FIG. 2 is a schematic diagram showing an example of a difference dictionary.

FIG. 3 is a flow chart describing the operation of portable telephone terminal 1.

FIG. 4 is a schematic diagram describing the operation of portable telephone terminal 1.

FIG. 5 is a schematic diagram describing the operation of portable telephone terminal 1.

### BEST MODES THAT CARRY OUT THE INVENTION

Next, with reference to the accompanying drawings, embodiments of the present invention will be described.

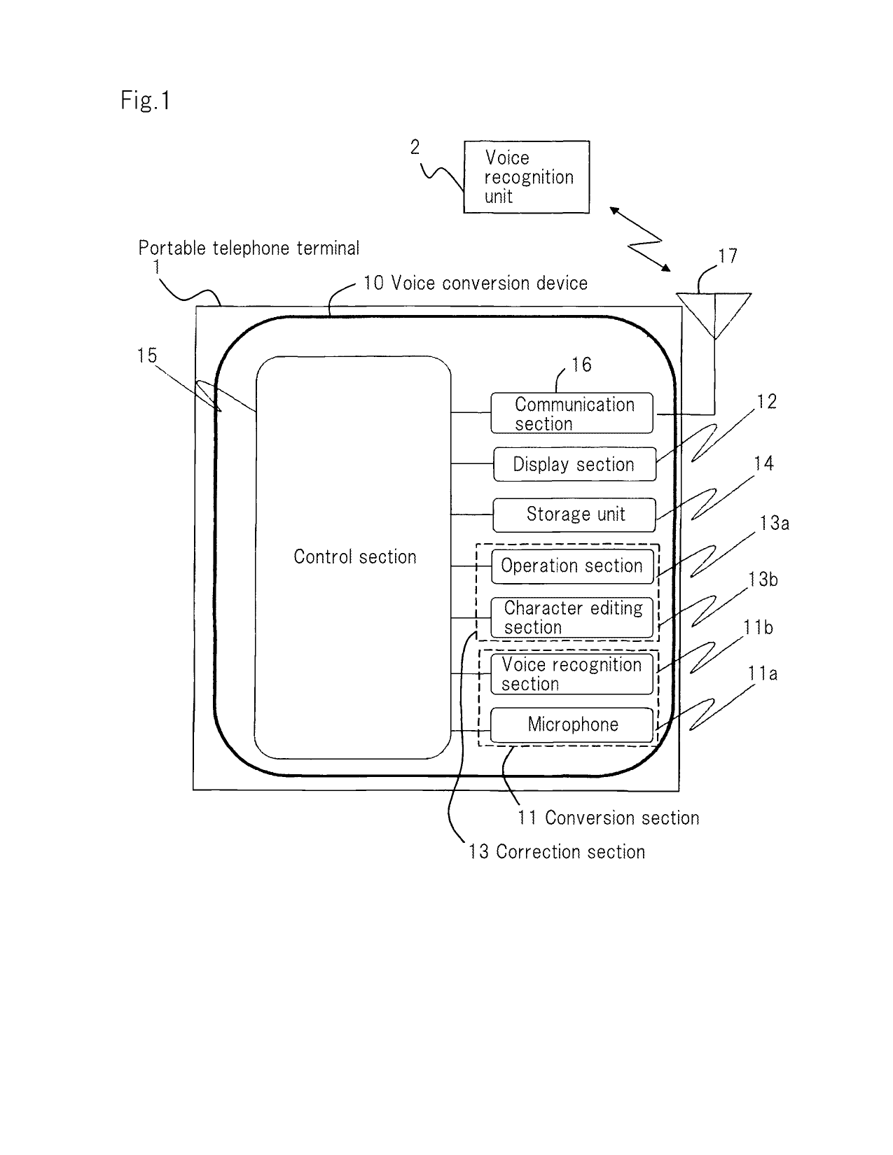

FIG. 1 is a block diagram showing portable telephone terminal 1 according to an embodiment of the present invention.

In FIG. 1, portable telephone terminal 1 has a function that handles character data of electronic mail and so forth. Portable telephone terminal 1 includes voice conversion device 10 according to an embodiment of the present invention.

Voice conversion device 10 includes conversion section 11, display section 12, correction section 13, storage unit 14, control section 15, communication section 16, and antenna 17. Conversion section 11 includes microphone 11 a and voice recognition section 11b. Correction section 13 includes operation section 13a and character editing section 13b.

Conversion section 11 can be generally referred to as voice recognition means.

Whenever conversion section 11 accepts a voice, conversion section 11 performs a voice recognition process for the voice so as to convert it into a character string.

Microphone 11a can be generally referred to as output means. Whenever microphone 11a inputs a user's voice, microphone 11a converts the user's voice into voice data and outputs the voice data. The voice data are supplied to voice recognition section 11b through control section 15.

Whenever voice recognition section 11b accepts voice data, voice recognition section 11b performs a voice recognition process for the voice data so as to convert the voice data into a character string and output the character string. According to this embodiment, voice recognition section 11b outputs a Kana character string (Kata Kana character string or Hiragana character string) (Kata Kana characters and Hiragana characters are Japanese characters that are used in Japanese writing as well as Kanji characters).

Display section 12 can be generally referred to as display means.

Display section 12 displays a character string that is output from voice recognition section 11b. In addition, display section 12 displays a character editing state that occurs in character editing section 13b.

Correction section 13 can be generally referred to as correction means.

Correction section 13 accepts a correction command that causes a word or a phrase (that is composed of one or more characters) that is a part of the character string that is output from voice recognition section 11b to be corrected. According to this embodiment, the correction command specifies a word or a phrase to be corrected and represents a corrected word or phrase.

When correction section 13 accepts the correction command, correction section 13 corrects a word or phrase of the character string specified by the correction command to a word or a phrase specified by the correction command to be a corrected word or phrase. Hereinafter, a word or a phrase specified by the correction command is referred to as “pre-corrected word or phrase,” whereas a word or a phrase specified by the correction command to be a corrected word or phrase is referred to as “post-corrected word or phrase.”

Operation section 13a is an operation button. The operation button may be displayed on display section 12. When the user operates operation section 13a, it accepts various inputs from the user (for example, correction command). When operation section 13a accepts the correction command, operation section 13a supplies the correction command to character editing section 13b through control section 15.

When character editing section 13b accepts the correction command, character editing section 13b edits a character string that is output from voice recognition section 11b corresponding to the correction command. According to this embodiment, when character editing section 13b accepts the correction command, character editing section 13b replaces a pre-corrected word or phrase of the character string with a post-corrected word or phrase.

Storage unit 14 can be generally referred to as storage means.

Storage unit 14 stores dictionaries (dictionary data) that character editing section 13b needs for the character editing process and that voice recognition section 11b needs for the voice recognition process.

In addition, storage unit 14 stores words and phrases (sets of pre-corrected words and phrases and post-corrected words and phrases) that character editing section 13b has edited. According to this embodiment, storage unit 14 stores a difference dictionary (difference dictionary data) that represents the contents of corrections. The difference dictionary contains pre-corrected words and phrases and post-corrected words and phrases that have been correlated with each other.

Control section 15 can be generally referred to as control means.

Control section 15 controls each section of portable telephone terminal 1.

When conversion section 11 converts a voice into a character string, if storage unit 14 has stored a corrected word or phrase of the character string, control section 15 generates selection candidates corresponding to the contents of corrections and displays the selection candidates as recognition result candidates of the voice on display section 12.

According to this embodiment, when conversion section 11 converts a voice into a character string, if storage unit 14 has stored a word or phase of the character string as a pre-corrected word or phrase, control section 15 generates a replaced character string in which the pre-corrected word or phrase of the character string is replaced with a post-corrected word or phrase correlated with the pre-corrected word or phrase as a selection candidate.

Control section 15 displays a post-corrected word or phrase on display section 12 in a display format that is different from that for characters other than the post-corrected word or phrase of the characters of the replaced character string. For example, control section 15 displays post-corrected characters of the replaced character string in a color, a size, or a font that is different from that for characters other than the post-corrected characters.

Communication section 16 can be generally referred to as communication means.

When external voice recognition unit 2 rather than voice recognition section 11b of portable telephone terminal 1 executes the voice recognition process, communication section 16 transmits voice data that are output from microphone 11a to voice recognition unit 2 through antenna 17 and then receives a character string as the conversion result of the voice data from voice recognition unit 2 through antenna 17.

Whenever voice recognition unit 2 accepts voice data, voice recognition unit 2 converts the voice data into a character string and transmits the conversion result (character string) to the sender of the voice data.

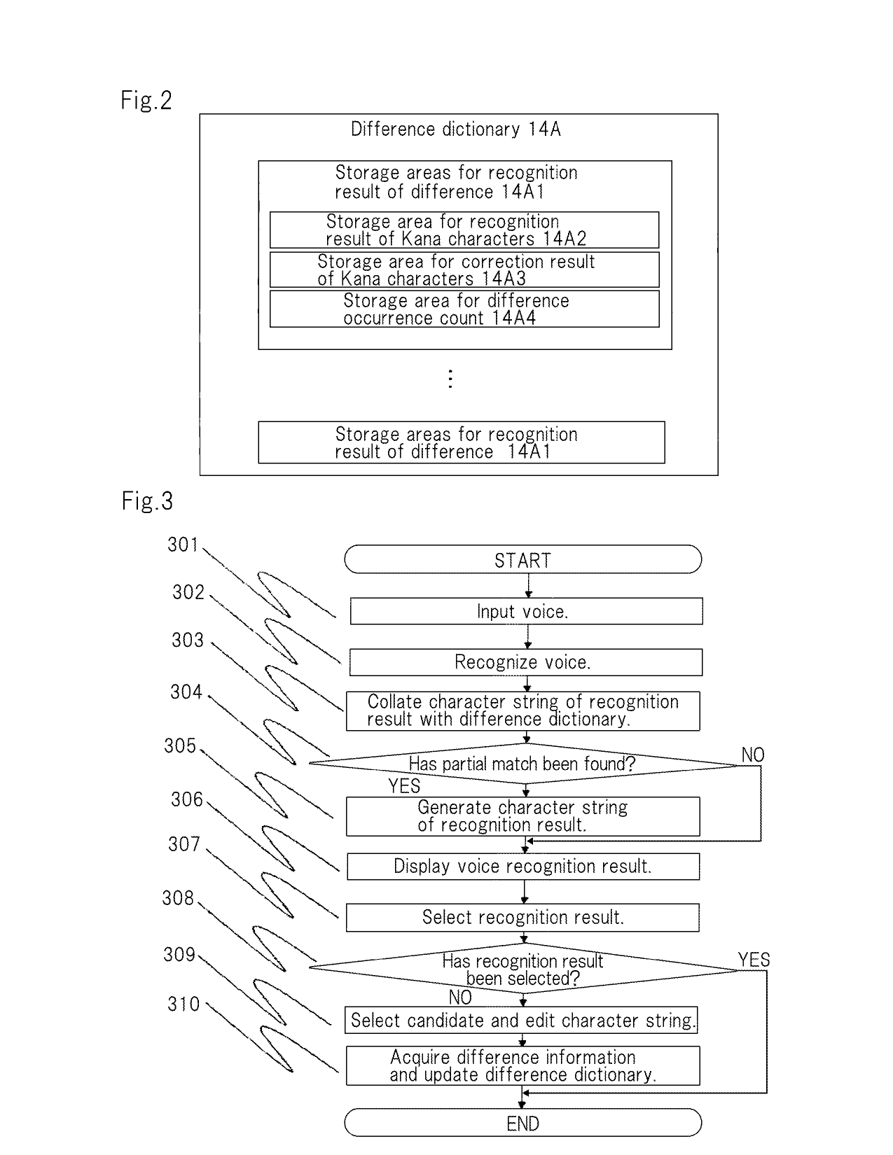

FIG. 2 is a schematic diagram showing an example of the difference dictionary (database) that storage unit 14 has stored.

In FIG. 2, difference dictionary 14A has a plurality of storage areas for recognizing the result of difference 14A1. Whenever the user corrects a word or a phrase of a Kana character string that is output from voice recognition section 11b using the correction command, control section 15 registers difference information of recognition result (contents of a correction) that represents the difference between the voice recognition result of voice recognition section 11b and the user's recognition to storage area for recognition result of difference 14A1.

Storage area for recognition result of difference 14A1 include storage area for recognition result of Kana characters 14A2, storage area for correction result of Kana characters 14A3, and storage area for difference occurrence count 14A4.

Storage area for recognition result of Kana characters 14A2 stores Kana characters that are a word or a phrase (a pre-corrected word or phrase) specified to be corrected by the correction command of a Kana character string that is output from voice recognition section 11 b (hereinafter these Kana characters are referred to as recognition result of Kana characters).

Storage area for correction result of Kana characters 14A3 stores Kana characters that are specified to be a post-corrected word or phrase by the correction command (hereinafter these Kana characters are referred to as “correction result of Kana characters.”

Storage area for difference occurrence count 14A4 stores the number of times “recognition result of Kana characters” stored in storage area for recognition result of Kana characters 14A2 has been corrected to “correction result of Kana characters” stored in storage area for correction result of Kana characters 14A3 (hereinafter, this number of times is referred to as “difference occurrence count.”

As shown in FIG. 2, according to this embodiment, storage unit 14 stores a plurality of sets of a pre-corrected word or phrase and a post-corrected word or phrase and the number of times a correction for each set has been executed (hereinafter, the number of times a correction for each set has been executed is referred to as “execution count.”)

When conversion section 11 converts a voice into a character string, if each of words or phrases of the character string has been stored as a pre-corrected word or phrase in storage unit 14, control section 15 generates a replaced character string in which each of words or phrases of the character string as a pre-corrected word or phrase has been replaced with a post-corrected word or phrase correlated with each of the pre-corrected words or phrases as a selection candidate.

Control section 15 decides the display order of selection candidates displayed on display section 12 based on the execution counts of sets used to generate the selection candidates and the number of characters of each of pre-corrected words or phrases used to generate the selection candidates.

Control section 15 assigns values to selection candidates, for example, in proportion to the execution count and the number of characters of each of the pre-corrected words or phrases. Control section 15 displays the selection candidates in the order of higher values assigned thereto on display section 12.

Voice conversion device 10 may be accomplished by a computer. In this case, when the computer reads a program from a record medium such as a CD-ROM (Compact Disk Read Only Memory) and executes the program, the computer can function as conversion section 11, display section 12, correction section 13, storage unit 14, and control section 15. The record medium is not limited to a CD-ROM, but may be of any type.

Next, the operation of this embodiment will be described in brief.

According to this embodiment, when the user corrects a voice recognition result recognized by voice recognition section 11b using character editing section 13b, difference information (recognition result of difference information) that represents the difference of Kana characters between the voice recognition result and the character string corrected by character editing section 13b is stored in storage unit 14 of portable telephone terminal 1.

Portable telephone terminal 1 generates a selection candidate based on the difference information as a result of the voice recognition process executed by voice recognition section 11b and displays the selection candidate as a voice recognition result candidate.

In addition, portable telephone terminal 1 generates a replaced character string in which a pre-corrected word or phrase (recognition result of Kana characters) of the character string that is output from voice recognition section 11b is replaced with a post-corrected word or phrase (correction result of Kana characters) as a selection candidate and displays the post-corrected characters of the replaced characters string in a color, size, or font that is different from that for characters of other than post-corrected characters.

Next, the operation of this embodiment will be described in detail.

FIG. 3 is a flow chart describing the operation of portable telephone terminal 1 corresponding to a user's operation.

When the user inputs characters to portable telephone terminal 1, he or she speaks a word or a phrase corresponding to the characters to microphone 11a (at step 301).

Microphone 11a converts the input voice into voice data. Thereafter, voice recognition section 11b or external voice recognition unit 2 executes the voice recognition process for the voice data. Thereafter, control section 15 acquires Kana information (character string) as a voice recognition result (at step 302).

Thereafter, control section 15 generates recognition result candidates as the voice recognition result of Kana information (character string). Character editing section 13b executes a Kanji character conversion process for the recognition result candidates. Control section 15 displays the recognition result candidates that have been converted into Kanji characters on display section 12.

When control section 15 generates recognition result candidates, control section 15 collates the voice recognition result of Kana information acquired this time with difference information stored in difference dictionary 14A (at step 303) and searches the recognition result of Kana characters of the difference information that partly matches the recognition result of Kana characters acquired this time (at step 304).

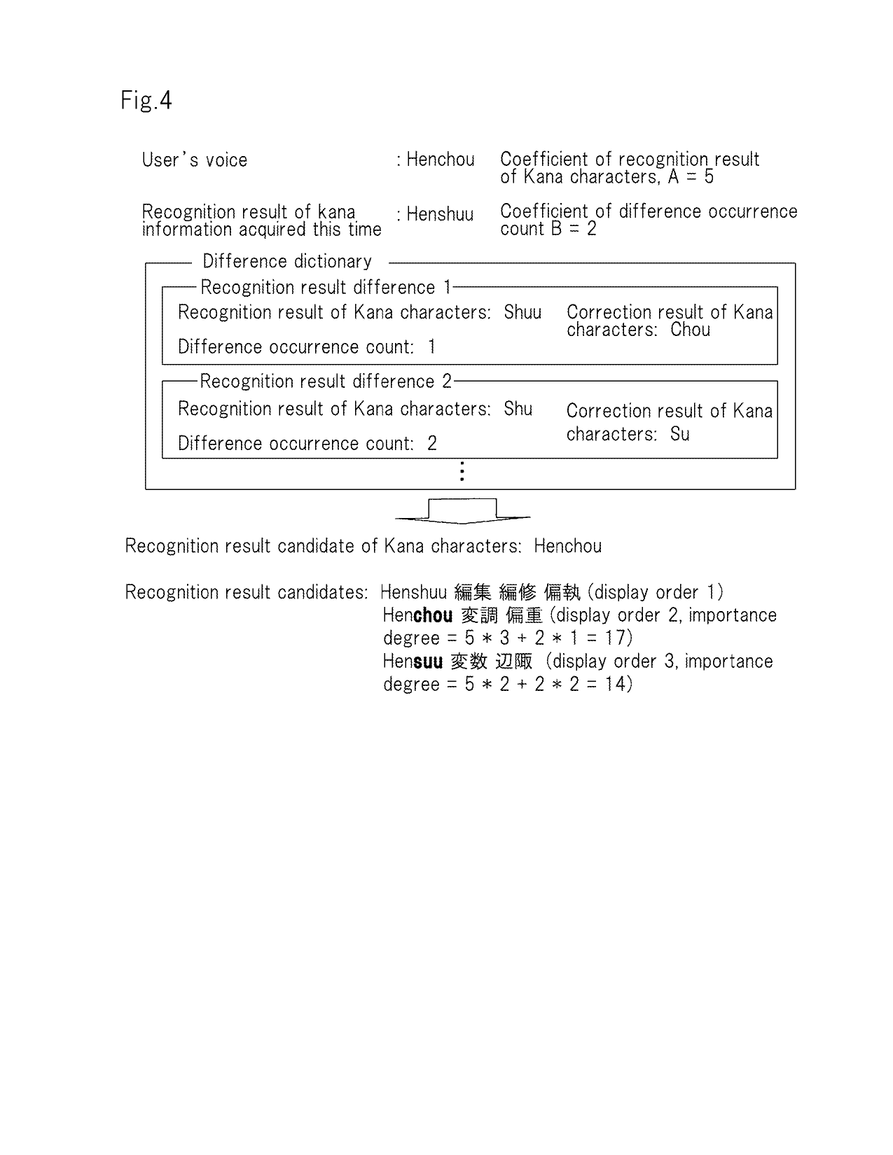

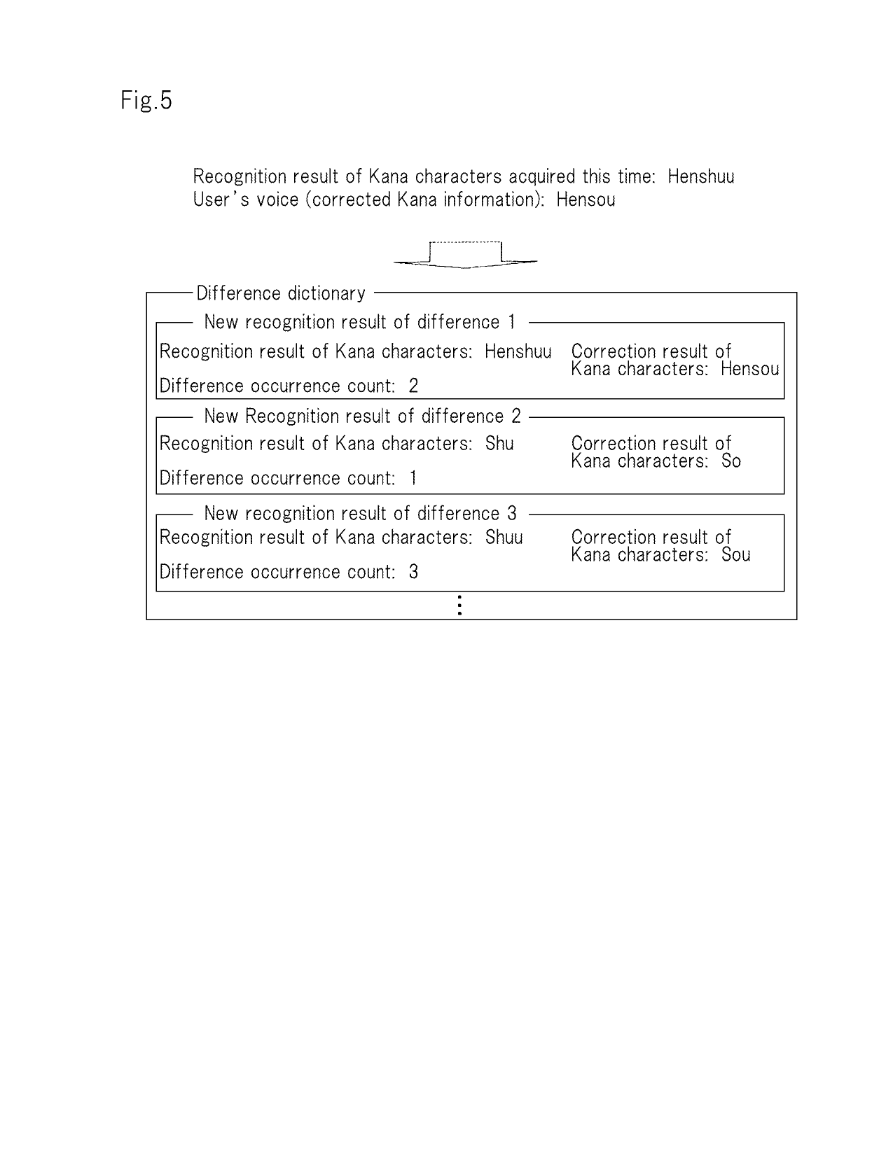

If difference dictionary 14A has stored difference information shown in FIG. 4, the user speaks “Henchou,” if and the voice recognition result of Kana information that the voice recognition engine of voice recognition section 11b or the voice recognition engine of voice recognition unit 2 has acquired is “Henshu,” when control section 15 collates the voice recognition result of Kana characters acquired this time with the recognition result of Kana characters stored in difference dictionary 14A, recognition results “shuu” and “shu” partially match. Control section 15 generates recognition result candidates of Kana characters (replaced character strings) in which Kana characters that match the recognition result of Kana characters of the voice recognition result of Kana characters acquired this time are replaced with the correction result of Kana characters correlated with the recognition result of Kana characters (at step 305).

If control section 15 has found a plurality of partial matches of Kana characters, control section 15 sets Kana character string length of recognition result, a, and difference occurrence count, b, for each recognition result of difference information used to generate recognition result candidates of Kana characters and executes a formula for importance degree n=A*a+B*b so as to acquire the importance degree, where n is the importance degree, A is the coefficient of recognition result of Kana characters, and B is the coefficient of difference occurrence count, both of which have been stored in control section 15.

According to this embodiment, the importance degree is calculated based on both the similarity between the recognition result and the voice that depends on the length of Kana character string of the recognition result and the difference occurrence count.

In the example shown in FIG. 4, if recognition result difference 1 is used, “Henchou” in which “shuu” of “Henshuu” was replaced with “Chou” becomes a recognition result candidate of Kana characters.

Substituting the coefficient of recognition result of Kana characters A=5 and the coefficient of difference occurrence count B=2 into the formula of importance degree n=A*a+B*b, Kana character string length of recognition result, a, becomes “3” and difference occurrence count, b, becomes “1,” resulting in n=A*a+B*b=5*3+2*1=17.

Likewise, in recognition result difference 2, “Hensuu” in which “shu” of “Henshuu” was replaced with “Su” becomes a recognition result candidate of Kana characters.

At this point, since Kana character string length of recognition result, a, becomes “2” and difference occurrence count b becomes “1,” the importance degree n becomes n=A*a+B*b=5*2+2*2=14.

Thus, control section 15 displays a recognition result candidate of Kana characters “Henchou” generated based on recognition result difference 1 and a recognition result candidate of Kana characters “Hensuu” generated based on recognition result difference 2 in the order on display section 12.

Character editing section 13b collates the recognition result candidates of Kana characters with character strings registered in a Japanese dictionary. Only if the recognition result candidates of Kana characters match character strings registered in the Japanese dictionary, the recognition result candidates of Kana characters will be displayed as recognition result candidates on display section 12. If the recognition result candidates of Kana characters do not match any character string registered in the Japanese dictionary, character editing section 13b determines that the recognition result candidates of Kana characters are not correct Japanese words and thereby control section 15 does not recognize the recognition result candidates of Kana characters as recognition result candidates.

Along with the voice recognition result of Kana information acquired this time, the recognition result candidates of Kana characters are displayed as recognition result candidates (at step 306). The voice recognition result of Kana characters acquired this time is displayed at the top and followed by recognition result candidates in the order of the degree of importance.

The replaced portions are highlighted against non-replaced portions using character color, character size, or font that is different from that for the non-replaced portion so as to allow the user to identify them.

In addition, control section 15 displays the result of a Kana-Kanji character conversion from recognition result candidates of Kana characters into Kanji characters that correction section 13 has performed as recognition result candidates on display section 12.

If control section 15 has not found a partial match, control section 15 displays a character string in which the voice recognition result of Kana information is converted into Kanji characters as a recognition result candidate on display section 12.

The user selects a character string corresponding to the word or phrase that he or she spoke from the recognition result candidates that are displayed (at step 307).

If the user selects the voice recognition result acquired this time, control section 15 determines that the word or phrase that the user spoke matches the voice recognition result and does not change the difference dictionary (at step 308). In contrast, if the user selects a recognition result candidate that is different from the voice recognition result acquired this time or corrects the voice recognition result using the character editing process (at step 309), control section 15 determines that there is a difference between the word or phrase that the user spoke and the voice recognition result, acquires the difference, and registers the difference in the difference dictionary (at step 310).

For example, although the user spoke “Hensou,” if “Henshuu” is acquired as a voice recognition result, he or she will correct “shu” to “so” using the character editing process.

At this point, date and time on and at which the voice recognition was performed, “Henshuu” as the recognition result of Kana characters, “Hensou” as the correction result of Kana characters, and the number of times the same correction was made as the difference occurrence count are stored as difference information in the difference dictionary.

At this point, difference information registered in the difference dictionary may be not only words and phrases, but a combination (set) of a recognition result of Kana characters “shu” that is only a corrected portion and a correction result of Kana character “so” and a combination (set) of a recognition result of Kana characters “shuu” in which characters that are followed by and preceded by the correction portion are added and a correction result of Kana characters “sou”.

The updated difference dictionary is reflected in the voice recognition process performed next time.

According to this embodiment, when conversion section 11 converts a voice into a character string, if a corrected word or phrase of the character string has been stored in storage unit 14, control section 15 generates selection candidates corresponding to the corrected word or phrase and displays the selection candidates as recognition result candidates of the character string on display section 12.

Thus, the user can be free from repeating the correction process (optimization process).

In addition, according to this embodiment, when control section 15 converts a voice into a character string, if a word or a phrase in the character string has been stored as a pre-corrected word or phrase in storage unit 14, control section 15 generates a replaced character string in which the pre-corrected word or phrase of the character string is replaced with a post-corrected word or phrase correlated with the pre-corrected word or phrase as a selection candidate. In this case, it is likely that a correction that was made in the past will be reproduced.

In addition, according to this embodiment, control section 15 displays the post-corrected word or phrase on display section 12 in a display format that is different from that for characters other than the post-corrected word or phrase. For example, control section 15 displays post-corrected characters of the replaced character string in a color, a size, or a font that is different from that for characters other than the post-corrected characters. In this case, the replaced portion can be highlighted against the non-replaced portion so as to allow the user to easily identify them. As a result, the user can easily recognize voice recognition errors that occur due to a user's speaking habit and the characteristics of the microphone.

As described above, according to this embodiment, the difference information can be reflected as information that represents the user's speaking habit and the characteristics of the microphone in a voice recognition result and the reflected result is presented to the user without it being necessary to rely on the voice recognition engine. As a result, the voice recognition result can be user-friendly displayed and he or she can know the characteristics of his or her voice.

The foregoing embodiment may be modified as follows.

Besides the formula n=A*a+B*b using the character string length and occurrence count as a technique that determines the degree of importance, another formula using time information such as data update date or parameters such as numeric information of similarities of consonants (“ma,” “mu,” and so forth) and vowels (“ka,” “ha,” and so forth) by comparing a recognition result of Kana characters and a correction result of Kana characters may be used.

Alternatively, data may be registered in the difference dictionary by the user himself or herself in addition to that the voice recognition is performed.

With reference to the embodiments, the present invention has been described. However, it should be understood by those skilled in the art that the structure and details of the present invention may be changed in various ways without departing from the scope of the present invention.

The present application claims priority based on Japanese Patent Application JP 2010-219053 filed on Sep. 29, 2010, the entire contents of which are incorporated herein by reference in its entirety.

### DESCRIPTION OF REFERENCE NUMERALS

1 Portable telephone terminal
10 Voice conversion device
11 Conversion section
11a Microphone
11b Voice recognition section
12 Display section
13 Correction section
13a Operation section
13b Character editing section
14 Storage unit
15 Control section
16 Communication section
17 Antenna
2 Voice recognition unit

1. A voice conversion device, comprising:
a voice recognition unit that accepts a voice and converts the voice into a character string;
a display unit that displays said character string;
a correction unit that accepts a correction command that causes a word or a phrase that is a part of a character string displayed on said display unit to be corrected and corrects said word or phrase corresponding to the correction command;
a storage unit that stores a word or a phrase corrected by said correction unit; and
a control unit that generates a selection candidate corresponding to the corrected word or phrase of the character string and displays the selection candidate as a recognition result candidate of said voice on said display unit if the corrected word or phrase has been stored in said storage unit when said voice recognition unit converts the voice into the character string.

2. The voice conversion device as set forth in claim 1,
wherein said storage unit stores a pre-corrected word or phrase that has not been corrected by said correction unit and a post-corrected word or phrase corrected by said correction unit, and
wherein said control unit generates a replaced character string in which a word or phrase specified as said pre-corrected word or phrase of the character string is replaced with said post-corrected word or phrase as said selection candidate if the specified word or phrase of the character string has been stored as said pre-corrected word or phrase in said storage unit when said voice recognition unit converts the voice into the character string.

3. The voice conversion device as set forth in claim 2,
wherein said control unit displays said post-corrected word or phrase in a display format that is different from that for characters other than the post-corrected word or phrase on said display unit.

4. A voice conversion device that is capable of communicating with a voice recognition unit that receives voice data, converts the voice data into a character string, and transmits the character string to a sender of said voice data, the voice conversion device comprising:
an output unit that converts an input voice into voice data;
a communication unit that transmits said voice data to said voice recognition unit and then receives a character string as a conversion result of said voice data from said voice recognition unit;
a display unit that displays said character string;
a correction unit that accepts a correction command that causes a word or a phrase that is a part of a character string displayed on said display unit to be corrected and corrects the word or phrase of said character string corresponding to the correction command;
a storage unit that stores a word or a phrase corrected by said correction unit; and
a control unit that generates a selection candidate corresponding to said corrected word or phrase of the character string and displays the selection candidate as a recognition result candidate of said voice on said display unit if the corrected word or phrase has been stored in said storage unit when said communication unit receives the character string from said voice recognition unit.

5. The voice conversion device as set forth in claim 4,
wherein said storage unit stores a pre-corrected word or phrase that has not been corrected by said correction unit and a post-corrected word or phrase that has been corrected by said correction unit, and
wherein said control unit generates a replaced character string in which a word or phrase specified as said pre-corrected word or phrase of the character string is replaced with said post-corrected word or phrase as said selection candidate if the specified word or phrase of the character string has been stored as said post-corrected word or phrase in said storage unit when said communication unit receives the character string from said voice recognition unit.

6. A portable telephone terminal that has a voice conversion device as set forth in claim 1.

7. A voice conversion method for a voice conversion device, the voice conversion method comprising:
accepting a voice and converting the voice into a character string;
displaying said character string on a display unit;
accepting a correction command that causes a word or a phrase that is a part of a character string displayed on said display unit to be corrected and correcting said word or phrase corresponding to the correction command;
storing said corrected word or phrase in a storage unit; and
generating a selection candidate corresponding to the corrected word or phrase of the character string and displaying the selection candidate as a recognition result candidate of said voice on said display unit if the corrected word or phrase has been stored in said storage unit when said voice is converted into the character string.

8-10. (canceled)

11. A portable telephone terminal that has a voice conversion device as set forth in claim 2.

12. A portable telephone terminal that has a voice conversion device as set forth in claim 3.

13. A portable telephone terminal that has a voice conversion device as set forth in claim 4.

14. A portable telephone terminal that has a voice conversion device as set forth in claim 5.
